(19) United States
(12) Patent Application Publication
(10) Pub. No.: US 2018/0009302 A1
(43) Pub. Date: Jan. 11, 2018

(54) GLASS COVER UNIT OF A SLIDING ROOF SYSTEM FOR AN AUTOMOTIVE VEHICLE AND METHOD FOR PRODUCING THE GLASS COVER UNIT

(71) Applicant: Carsten BAUHAMMER, Schopfloch (DE)

(72) Inventor: Carsten BAUHAMMER, Schopfloch (DE)

(21) Appl. No.: 15/642,743

(22) Filed: Jul. 6, 2017

(30) Foreign Application Priority Data
Jul. 7, 2016 (DE) 10 2016 212 424.2

(51) Int. Cl. F16J 15/10; B60J 7/043

(52) U.S. Cl. CPC B60J 10/82; F16J 15/102; B60J 10/15; B60J 7/043

(57) ABSTRACT

1. Glass cover unit of a sliding roof system for an automotive vehicle and method for its production.

2.1 A glass cover unit comprising a glass cover and a metallic carrier arrangement and an in-place foamed synthetic material, said foamed material being provided in a boundary area of the glass cover and fixing the metallic carrier arrangement in relation to a bottom side of the glass cover, wherein a sealing insert is provided between a top side of the metallic carrier arrangement and the bottom side of the glass cover to ensure spacing of the top side of the metallic carrier arrangement from the bottom side of the glass cover, is known.

2.2 According to the invention, the sealing insert is a sealing bead configured using a deformable material which extends in an annular shape on the metallic carrier arrangement, which adheres to the metallic carrier arrangement, and has bead ends adjoining in alignment joint to joint.

2.3 Use with passenger vehicles.

### CROSS-REFERENCE TO RELATED APPLICATION

This claims priority from German Patent Application No. DE 10 2016 212 424.2, filed Jul. 7, 2016, the disclosure of which is hereby incorporated by reference in its entirety.

### FIELD OF THE INVENTION

The invention relates to a glass cover unit of a sliding roof system for an automotive vehicle, comprising a glass cover and a metallic carrier arrangement and an in-place foamed synthetic material, said foamed material being provided in a boundary area of the glass cover and fixing the metallic carrier arrangement in relation to a bottom side of the glass cover, wherein a sealing insert is provided between a top side of the metallic carrier arrangement and the bottom side of the glass cover to ensure spacing of the top side of the metallic carrier arrangement from the bottom side of the glass cover.

The invention also relates to a method for producing such a glass cover unit.

### BACKGROUND OF THE INVENTION

DE 35 06 009 C2 discloses such a glass cover unit for a sliding roof system of an automotive vehicle. Said glass cover unit includes a glass cover and a metallic carrier arrangement used for holding corresponding functional components of the sliding roof system. For securing the metallic carrier arrangement on the bottom side of the glass cover, an in-place foamed synthetic material is provided and, upon curing, builds a rigid interconnection between the metallic carrier arrangement and the glass cover. The metallic carrier arrangement has a groove-type recess, provided circumferentially in the frame-shaped metallic carrier arrangement. A continuous circumferential sealing cord is inserted in the recess. Said sealing cord is deformed by the in-place foamed synthetic material together with the glass cover and is pressed into the groove-type recess.

### SUMMARY OF THE INVENTION

It is the object of the invention to provide a glass cover unit and a method of the type mentioned at the beginning, which are further improved in relation to the prior art.

This object is achieved for the glass cover unit in that the sealing insert is designed as a sealing bead made of a deformable material which extends in an annular shape on the metallic carrier arrangement, which adheres to the metallic carrier arrangement, and has bead ends adjoining in alignment joint to joint. According to the invention is therefore provided a deformable material strand which adheres to the metallic carrier arrangement and is applied to the metallic carrier arrangement in a continuously circumferential pattern. The solution according to the invention is with particular advantage adapted to a sliding roof system of a passenger vehicle. The glass cover is preferably provided with an additional splinter shield film in the region of its bottom side, which film extends over the entire bottom side of the glass cover and adheres over the area to the bottom side of the glass cover. A polyurethane (PU) foam is preferably provided as the in-place foamed synthetic material. In that the sealing insert is configured as a sealing bead adhering to the metallic carrier arrangement, the sealing bead can be applied to a planar surface of the metallic carrier arrangement. In contrast to the prior art, where a groove-type recess had to be provided for the sealing cord, the sealing bead accordingly maintains a stable orientation even on a planar surface of the metallic carrier arrangement, without any need for matching the metallic carrier arrangement thereto. As a result, a cost-efficient design of the metallic carrier arrangement is achievable. Moreover, the total height of the glass cover unit composed of glass cover, sealing bead and metallic carrier arrangement can be reduced. The bead ends adjoining in alignment joint to joint ensure that a secure sealing of the gap left between the glass cover bottom side and the top side of the metallic carrier arrangement is achieved even in the region of the facing bead ends, in order to ensure that the in-place foamed synthetic material can penetrate from the exterior merely up to the sealing bead between the glass cover bottom side and the top side of the metallic carrier arrangement.

In an embodiment of the invention, the sealing bead is composed of a sealing compound processible in a liquid or flowing condition. The sealing compound is applied to the metallic carrier arrangement continuously in the form of a corresponding strand, thereby forming the sealing bead. The sealing bead has a bulge-type elevation relative to the top side of the metallic carrier arrangement and will be deformed, once the glass cover is placed on and the in-place foamed synthetic material is applied.

In a further embodiment of the invention, a PU soft foam or hard foam, an adhesive, silicone or a similar material is provided as a sealing compound. Said embodiment is particularly advantageous in order to maintain the desired spacing of the metallic carrier arrangement in relation to the bottom side of the glass cover in the completed final condition.

In a further embodiment of the invention, a single-component or multi-component synthetic material is provided as a sealing compound. The synthetic material can be configured as a two-component or three-component material. With a two-component version, preferably one component is provided as a hardener component.

In a further embodiment of the invention, the metallic carrier arrangement is provided with a coating, in particular applied by cathodic dip coating. As a result, adhering of the sealing bead to the metallic carrier arrangement is further improved.

For the method, the object of the invention is achieved in that the sealing bead is applied to the metallic carrier arrangement in an annular circumferential pattern, in that then the metallic carrier arrangement is placed into an in-place foaming tool, in that subsequently the glass cover is placed onto the sealing bead and the metallic carrier arrangement, whereby the sealing bead is deformed, and in that finally the in-place foamed synthetic material is provided, which encloses the metallic carrier arrangement and the boundary area of the glass cover, penetrates from the exterior circumferentially up to the sealing bead between the metallic carrier arrangement and the bottom side of the glass cover, and cures there. The sealing bead adheres to the surface of the metallic carrier arrangement as early as during application to the metallic carrier arrangement and remains deformable, at least for the time until the glass cover is placed onto the sealing bead and the metallic carrier arrangement. Advantageously, the sealing bead has a relatively high viscosity to prevent that the sealing bead spreads after application to the metallic carrier arrangement.

In an embodiment of the method, the sealing bead is applied to the metallic carrier arrangement manually or in an at least partially automated procedure. In case of completely automated application of the sealing bead, the sealing bead is squeezed out of a corresponding sealing compound container, preferably using a robot, and applied circumferentially to the surface of the metallic carrier arrangement by means of the robot. The sealing bead is applied in a continuous circumferential manner in such a way that the bead ends are approached joint to joint and in mutual alignment. The viscosity of the sealing bead is selected such that the bead ends converge at least to a minor extent, whereby an at least largely seamless transition of the sealing bead in the region of the bead ends is obtained.

Further advantages and features of the invention will become apparent from the claims and also from the description below of a preferred exemplary embodiment of the invention, illustrated with reference to the drawings.

### BRIEF DESCRIPTION OF THE DRAWINGS

FIG. 1 shows a perspective illustration of an embodiment of a glass cover unit according to the invention for a sliding roof system of a passenger vehicle;

FIG. 2 shows a schematic top view of the glass cover unit according to FIG. 1;

FIG. 3 shows a schematic and enlarged illustration of a section through the glass cover unit according to FIG. 2 along the sectional line III-III in FIG. 2;

FIG. 4 shows a sectional view similar to FIG. 3, however, with a glass cover and a synthetic material foam omitted; and

FIG. 5 shows a longitudinal sectional view along the sectional line V-V in FIG. 4.

### DETAILED DESCRIPTION

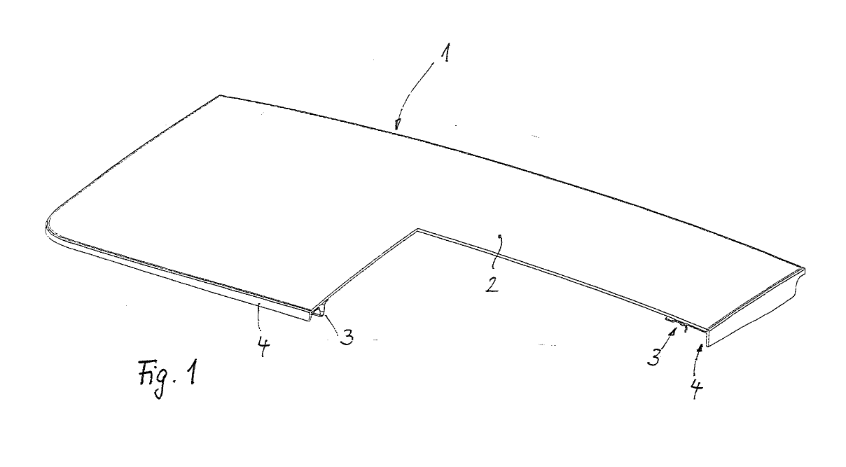

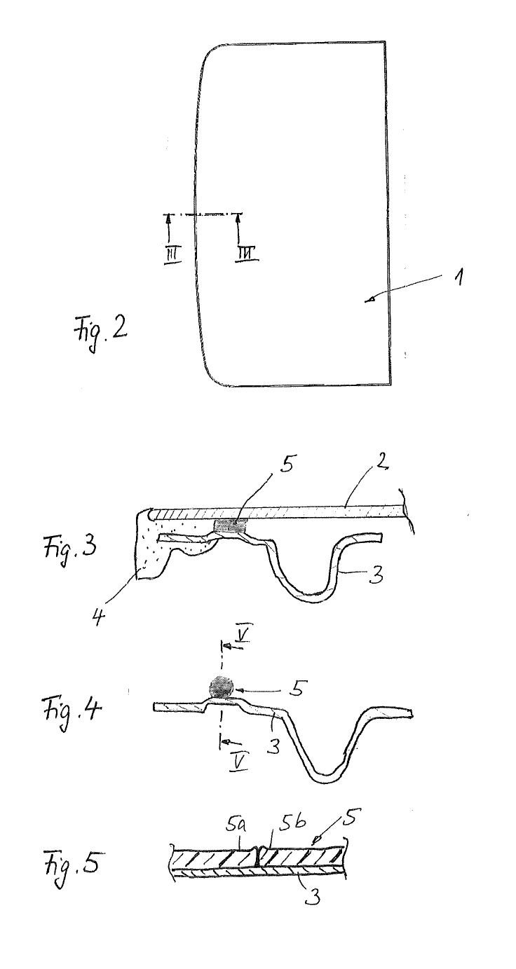

A passenger vehicle has in the roof portion thereof a sliding roof system which is provided with a glass cover unit 1 according to FIGS. 1 to 3. The glass cover unit 1 includes a glass cover 2 associated with a frame-shaped metallic carrier arrangement 3, made of a steel or an aluminum alloy, in the region of the bottom side thereof. The metallic carrier arrangement 3 is intended for holding corresponding functional components of the sliding roof system, used for displacing the glass cover unit 1 between a closed position, a ventilation position and an open position relative to a roof opening portion of the sliding roof system. The metallic carrier arrangement 3 extends essentially in parallel to corresponding boundary areas of the glass cover 2 and is fixed to the glass cover 2 by means of a dimensionally stable in-place foamed synthetic material 4. The in-place foamed synthetic material 4 extends circumferentially over an entire boundary area of the glass cover 2 and holds the metallic carrier arrangement 3 fixed at a short spacing in relation to a bottom side of the glass cover 2. For maintaining the spacing of a top side of the metallic carrier arrangement 3 in relation to the bottom side of the glass cover 2, a circumferential sealing bead 5 is provided between the glass cover 2 and the metallic carrier arrangement 3, which bead adheres to a top side of the metallic carrier arrangement 3 and is deformed in the completely mounted final condition according to FIG. 3. With reference to FIGS. 4 and 5, the adhering of the sealing bead 5 to the top side of the metallic carrier arrangement 3 is apparent, prior to placing-on the glass cover 2 and applying the in-place foamed synthetic material 4. The sealing bead 5 is formed by a flowable, preferably gel-type or cream-type sealing compound which is applied to the surface of the metallic carrier arrangement 3 continuously in a strand, circumferentially alongside the frame-shaped metallic carrier arrangement 3, and adheres to the surface, i.e., the top side, of the metallic carrier arrangement 3. A single-component or two-component adhesive, a PU soft foam or hard foam, or silicone, or a similar material is provided as the sealing compound. With reference to FIG. 5, it is apparent that the sealing bead is laid-out during continuous application along the metallic carrier arrangement 3 in such a manner that a terminal bead end 5b of the sealing bead 5 is adjoined directly to the joint of an initial bead end 5a in true alignment with said initial bead end 5a such that the initial bead end 5a and the terminal bead end 5b converge at least to a minor extent and, thus, allow an at least largely seamless transition in the region of the bead ends of the sealing bead 5. Thereby, an annular circumferential sealing bead is created, which ensures a secure barrier for the in-place foamed synthetic material 4 over an entire periphery of the glass cover 2 and the metallic carrier arrangement 3.

For producing the glass cover unit 1, at first the sealing bead 5 is applied manually or in an automated manner onto the surface of the metallic carrier arrangement 3 in the form of a strand. Subsequently, the metallic carrier arrangement 3 is inserted into an appropriate in-place foaming tool. Then, the glass cover 2 is placed onto the sealing bead 5 of the metallic carrier arrangement 3 and additionally pressed on, as required, whereby the sealing bead 5 is deformed according to the schematic illustration of FIG. 3. In a final step, the in-place foaming synthetic material 4 is applied in the foaming tool, which foam extends circumferentially over the entire periphery of the glass cover 2 and the metallic carrier arrangement 3, and which foam penetrates from the exterior into a remaining gap between the top side of the metallic carrier arrangement 3 and the bottom side of the glass cover 2 up to a boundary contour of the sealing bead 5 (FIG. 3). After curing of the in-place foamed synthetic material 4, the completed glass cover unit 1 is removed from the foaming tool and assembled with the respective functional components of the sliding roof system.

The metallic carrier arrangement 3 is configured as a metal sheet bent component and has circumferentially in the region of the sealing bead 5 an upwards protruding bulge, the surface thereof forming a planar application platform for the sealing bead 5. The bulge extends over the entire periphery of the metallic carrier arrangement 3.

The metallic carrier arrangement 3 includes a frame-shaped bent structure made of sheet metal, with the sheet thickness thereof being between 3 and 4 mm. By placing on the glass cover 2 and applying additional pressure onto the glass cover 2 from above, as required, the sealing bead 5 is compressed to an amount that between the top side of the metallic carrier arrangement 3, i.e., the application platform for the sealing bead, and the bottom side of the glass cover 2 a circumferential equal spacing of about 1 mm is obtained. The top side of the metallic carrier arrangement 3 is to mean in the region of the top side of the bulge of the metallic carrier arrangement 3 so that, de facto, the sealing bead is compressed to a thickness of about 1 mm. The sealing bead 5 adheres to the top side of the metallic carrier arrangement 3. However, the sealing bead does not adhere to the bottom side of the glass cover 2 and the splinter shield film, respectively. Fixing of the glass cover 2 in relation to the metallic carrier arrangement 3 is, indeed, exclusively via the in-place foamed synthetic material 4.

1. A glass cover unit of a sliding roof system for an automotive vehicle, comprising a glass cover and a metallic carrier arrangement and an in-place foamed synthetic material, said foamed material being provided in a boundary area of the glass cover and fixing the metallic carrier arrangement in relation to a bottom side of the glass cover, wherein a sealing insert is provided between a top side of the metallic carrier arrangement and the bottom side of the glass cover to ensure spacing of the top side of the metallic carrier arrangement from the bottom side of the glass cover, wherein the sealing insert is a sealing bead configured using a deformable material which extends in an annular shape on the metallic carrier arrangement, which adheres to the metallic carrier arrangement, and has bead ends adjoining in alignment joint to joint.

2. The glass cover unit according to claim 1, wherein the sealing bead is composed of a sealing compound processible in a liquid or flowing condition.

3. The glass cover unit according to claim 2, wherein a PU soft foam or hard foam, an adhesive, silicone, or a similar material is provided as a sealing compound.

4. The glass cover unit according to claim 3, wherein a single-component or multi-component material is provided as a sealing compound.

5. The glass cover unit according to claim 1, wherein the metallic carrier arrangement is provided with a coating, in particular applied by cathodic dip coating.

6. A method for producing a glass cover unit according to claim 1, wherein the sealing bead is applied to the metallic carrier arrangement continuously and in an annular circumferential pattern, in that then the metallic carrier arrangement is placed into an in-place foaming tool, in that subsequently the glass cover is placed onto the sealing bead and the metallic carrier arrangement, whereby the sealing bead is deformed, and in that finally the in-place foamed synthetic material is provided, which encloses the metallic carrier arrangement and the boundary area of the glass cover, penetrates from the exterior circumferentially up to the sealing bead between the metallic carrier arrangement and the bottom side of the glass cover, and cures there.

7. The method according to claim 6, wherein the sealing bead is applied to the metallic carrier arrangement manually or in an at least partially automated procedure.
